(19) United States
(12) Patent Application Publication
(10) Pub. No.: US 2008/0319917 A1
(43) Pub. Date: Dec. 25, 2008

(54) Bidding for position placement in a search result on time-limited resources

(76) Inventors: Keith Berenstein, San Francisco, CA (US); Sandip Chokshi, Palo Alto, CA (US); David M. Moore, San Francisco, CA (US); Antony Sargent, Belmont, CA (US); Rafael Z. Weinstein, San Francisco, CA (US); Daniel L. Willhite, San Francisco, CA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/133,833

(22) Filed: Jun. 5, 2008

Related U.S. Application Data
(60) Provisional application No. 60/924,987, filed on Jun. 7, 2007.

(51) Int. Cl. G06Q 30/00; G06Q 10/00

(52) U.S. Cl. 705/80; 705/26; 705/10

(57) ABSTRACT

A method, computer program product, and system are provided for bidding for position placement in a search result on time-limited resources. For example, an embodiment of the method includes receiving a bid for position placement of the time-limited resource in the search result, calculating the bid based on historical data of the time-limited resource, and ordering the search result based on the bid and relevance between a search term and attributes of the time-limited resource. In receiving the bid, the method can vary an amount of the bid for one or more time periods of interest, thus allowing flexibility for an owner/manager of the resource to offer bids for various time periods. The calculation of the bid is based on historical data of the resource, which can assess a likelihood that a consumer will click on a link associated with the resource, inquire further information on the resource, or book the resource. In turn, the search result can order one or more results from the search primarily on relevance between a number of similarities between inquiry and characteristics of the resource and secondarily on bid amount. One advantage of this method, among others, is that the method provides relevancy in a bid for placement advertising model and efficiently facilitates the bidding process for advertisers with multiple resources.

### CROSS REFERENCE TO RELATED APPLICATION

This application claims the benefit of U.S. Provisional Application No. 60/924,987 (SKGF Ref. No. 2605.0010000), filed Jun. 7, 2007, titled “Inferred Availability of Time Limited Resources, and Advertising Model Enabling Bidding by Time Periods,” which is incorporated herein by reference in its entirety.

### BACKGROUND

1. Field

The present invention relates generally to bidding for position placement in a search result on time-limited resources.

2. Background

The travel and service industries constitute a significant market in today's economy. For instance, the U.S. travel industry is a multi-billion dollar industry where a significant portion of this market is attributed to the airline, hotel, and tourist attraction segments. In light of the industry's success, many travel and service industry providers constantly seek ways to attract new and return customers.

One factor that affects a customer's decision to visit a particular location is the time of season. For example, a ski lodge may not attract as many customers during warmer seasons, such as spring and summer, as compared to the winter season. A beach resort, on the other hand, may not attract as many customers during the winter season as compared to a warmer season, like summer. Depending on the time of season, travel and service industry providers face a challenge in not only attracting new and return customers during a “peak” time of season, but also in optimizing its customer base during a “non-peak” time of season when there is a decline in the number of customers that visit a particular location. Furthermore, with the ever-growing number of location and attraction options for consumers, travel and service providers face an even greater challenge in not only growing but also maintaining a consistent customer base throughout the year.

Accordingly, what is needed is a method for travel and service providers to market themselves in a cost-effective manner, while achieving commercial success.

### SUMMARY

Embodiments of the invention include a method for bidding for position placement in a search result on time-limited resources. The method includes receiving a bid for position placement of the time-limited resource in the search result, calculating at least one of an inquiry rate and click-through rate based on historical data of the time-limited resource, and ordering the search result based on the at least one of the bid, the inquiry rate, and the click through rate and relevance between a search term and attributes of the time-limited resource. The method can also include displaying the ordered search result for an on-line consumer and negotiating a transaction between the consumer and an owner/manager of the time-limited resource.

In receiving the bid for position placement, an amount of the bid can vary for one or more time periods of interest. This step provides flexibility for an owner/manager of the resource to offer bids for various time periods. In addition, an owner/manager with multiple properties can offer a variety of bids based on a time period of interest for each resource.

In calculating the bid based on historical data, this step can assess a likelihood that an on-line consumer click-throughs, inquires, or books the time-limited resource. The likelihood assessment can include calculating a ratio representative of a number of click-throughs associated with the time-limited resource that converts into an inquiry on the time-limited resource. The likelihood assessment can also include calculating a ratio representative of the number of inquiries on the time-limited resource that converts into a booking of the time-limited resource.

In ordering the search result, this step can order one or more results from the inquiry search primarily on a number of similarities between the search term and characteristics of the time-limited resource and secondarily on an amount of the at least one of the bid, the inquiry rate, and the click-through rate. This bid amount can be based on a click-through, inquiry, and/or booking made by an on-line consumer using a marketing/transfer system provided by, for example, an online marketing service. In the instance that historical data for a resource is unknown, the position placement of the time-limited resource can be random so that the click-through, inquiry, and/or booking rate of the resource can be assessed.

Embodiments of the invention additionally include a computer program product comprising a computer-usable medium having computer program logic recorded thereon for enabling a processor to bid for position placement in a search result on time-limited resources. The computer program logic includes a receiving means for enabling a processor to receive a bid for position placement of the time-limited resource in the search result, a calculating means for enabling a processor to calculate at least one of an inquiry rate and a click-through rate based on historical data of the time-limited resource, and an ordering means for enabling a processor to order the search result based on the at least one of the bid, the inquiry rate, and the click-through rate and relevance between a search term and attributes of the time-limited resource. In addition, the computer program logic can also include a displaying means for enabling a processor to display the ordered search result for an on-line consumer and a negotiating means for enabling a processor to negotiate a transaction between the consumer and an owner/manager of the time-limited resource.

Embodiments of the invention further include a system for bidding for position placement in a search result on time-limited resources. The system includes a first module to receive a bid for position placement of the time-limited resource in the search result, a second module to calculate at least one of an inquiry rate and a click-through rate based on historical data of the time-limited resource, and a third module to order the search result based on the at least one of the bid, the inquiry rate, and the click-through rate and relevance between a search term and attributes of the time-limited resource. The system can also include a fourth module to display the ordered search result for an on-line consumer and a fifth module to negotiate a transaction between the consumer and an owner/manager of the time-limited resource.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 is an illustration of a conventional method for bidding for position placement in a search result on time-limited resources.

FIG. 2 is an illustration of an example computing environment in which the present invention can be implemented.

FIG. 3 is an illustration of an embodiment of a method for bidding for position placement in a search result on time-limited resources.

FIG. 4 is an illustration of an embodiment of a step for acquiring historical data in a method for bidding for position placement in a search result on time-limited resources.

FIG. 5 is an illustration of an example user interface that can be used by a property manager to enter bids for a given resource for different periods of time.

FIG. 6 is an illustration of an embodiment of a step for ordering a search result in a method for bidding for position placement in a search result on time-limited resources.

FIG. 7 is an illustration of another embodiment of a step for ordering a search result in a method for bidding for position placement in a search result on time-limited resources.

FIG. 8 is an illustration of an example scenario where an on-line consumer inquires about a rental vacation property and a property manager of the vacation property responds to the inquiry.

FIG. 9 is an illustration of an example scenario where an on-line consumer inquires about a rental vacation property and a property manager of the vacation property does not respond to the inquiry.

FIG. 10 is an illustration of another embodiment of a step for ordering a search result in a method for bidding for position placement in a search result on time-limited resources.

FIG. 11 is an illustration of an example scenario where an on-line consumer inquires about a rental vacation property, a property manager offers to rent the vacation property, and the consumer declines the offer.

FIG. 12 is an illustration of an example computer system in which the present invention can be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the relevant art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

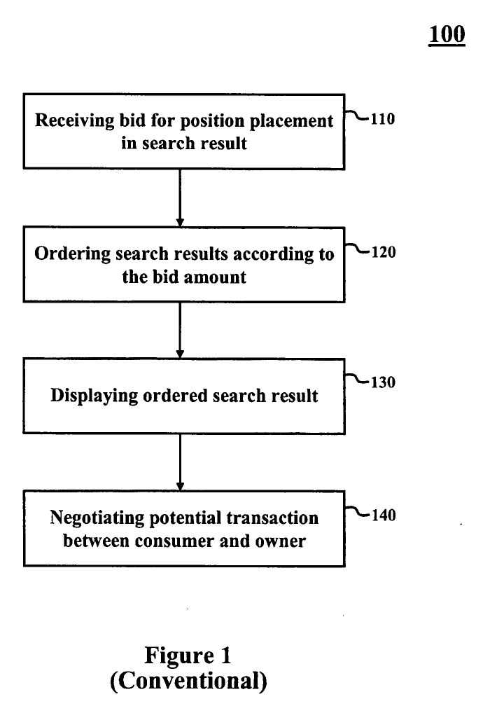

FIG. 1 is an illustration of a conventional method 100 for bidding for position placement in a search result on time-limited resources. With the emergence of e-commerce, many advertisers such as, for example, travel and service providers, heavily rely on on-line marketing services to attract new customers. One form of on-line marketing is known as “bid for placement,” where advertisers select keywords and bid per click for the first link placement in a search result using those terms. The top bidder on a specific keyword receives the top spot in the search result for that term, the second-highest bidder receives the second spot, and so forth. In the travel and service industry, this type of service can be used to market and transfer (e.g., sell, rent, or lease) a wide variety of “time-limited” resources such as, for example, rental homes, cruise ship tours, and airline tickets.

As used herein, a time-limited resource is a resource that has finite availability and inventory for any given period of time. For example, a rental home can be considered a time-limited resource since it is rented to one party for a given time period and typically cannot be rented to another party for the same time period. A ticket for a cruise ship or a museum tour can also be considered time-limited resources because they have finite availability (e.g., a ticket for a cruise ship is only valid for the length of the cruise and the museum tour is only valid for the length of the tour) and inventory (e.g., a number of cabins in the cruise ship and a number of spots available on the tour).

In referring to step 110 in FIG. 1, a bid is received by an on-line marketing service for position placement in an on-line search result. For instance, a hotel manager/owner can place a bid with an on-line marketing service for the term “beachfront hotel” so that his hotel can appear at or near the top of a search result using this term. It is well known that the “click-through” rate for an on-line consumer is relatively high for the first few items in a search result and decreases quickly and dramatically for items listed later in the list. Thus, the hotel manager/owner can seek to optimize his chances to be listed near or at the top of the list by offering a relatively large bid for the term. Moreover, a situation often arises when a property owner has several resources and, as a result, can submit additional bids for each resource. In the case where the properties are not substantially the same, the property owner can also offer bids for different amounts based on the search term used for each resource.

In step 120, the search results from an on-line consumer's inquiry are ordered according to the bid amount. In the example of the hotel manager/owner, the manager/owner will likely compete against other hotel owners for an optimal position in the search result list and, depending on the bid amount, may not be at the top of the list.

In step 130, the ordered search results are displayed to the on-line consumer. The on-line consumer can browse the search result and inquire further about an item on the list. In continuing with the example above, the on-line consumer can click on the link associated with the hotel owner/manager's property and inquire additional information on the hotel. The on-line consumer can make an inquiry on, for example, a confirmation of available dates, amenities available at the hotel, or whether pets are permitted on the premises. Since the on-line consumer clicked on the hotel manager/owner's link, the hotel manager/owner pays the on-line marketing service the bid amount from step 110.

In step 140, if the on-line consumer is satisfied with an item on the search result list, then the consumer and manager/owner of the resource can negotiate a potential transaction (e.g., rent, lease, or purchase) for the time-limited resource. In the hotel example above, the hotel manager/owner and the on-line consumer can negotiate a nightly or weekly rate.

A drawback of conventional method 100 is that the success of an advertiser's link is dependent on how much the advertiser is willing to pay for a search term rather than the ad's relevance to the search term used. For instance, in the hotel example described above, a rental car dealer can place a bid for the term “beachfront hotel” and outbid the hotel manager/owner for a top position in a search result using this term. The click-through rate for an on-line customer searching for this term, as a result, is reduced for the hotel manager/owner since his listing will be further down the search result list than the listing of the rental car dealer.

Another drawback of conventional method 100 is that a manager/owner with multiple time-limited resources may have difficulty in tracking bids for each resource. For example, a property manager can have 20 time-limited resources that she needs to rent throughout the year, where the resources are in various locations ranging from dry, arid locations to mountainous, high-altitude locations. Depending on the time of year, one location can be in a peak time of season to visit versus another location that is in a non-peak time of season. The property in the location experiencing the peak time of season for visitors may not require as high a bid for placement in a search result than the location in the non-peak time of season because it is more likely to attract customers than the other location. Here, the property manager faces a daunting task of individually tracking each property during different times of the year to ensure that an appropriate bid is offered for each property. In other words, it is desirable for the property manager to avoid overbidding for search terms associated with the property in the peak time of season and, at the same time, avoid underbidding for search terms associated with the property in the non-peak time of season.

With the ever-growing number of locations and attractions for customers to visit, managers and owners of time-limited resources such as, for example, those resources in the travel and service industry, face a great challenge in not only growing but also maintaining a consistent customer base throughout the year. A method is needed to provide relevancy in a bid for placement search result and to efficiently facilitate the bidding process for advertisers with multiple resources to overcome the drawbacks of conventional method 100.

In the following description, for purposes of explanation, specific details are set forth to provide a thorough understanding of the present invention. It will be evident, however, to one skilled in the relevant art that the present invention can be practiced without these specific details. In other instances, well-known circuits, structures, and techniques are not shown in detail, but rather in a block diagram in order to avoid unnecessarily obscuring an understanding of this description.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment.

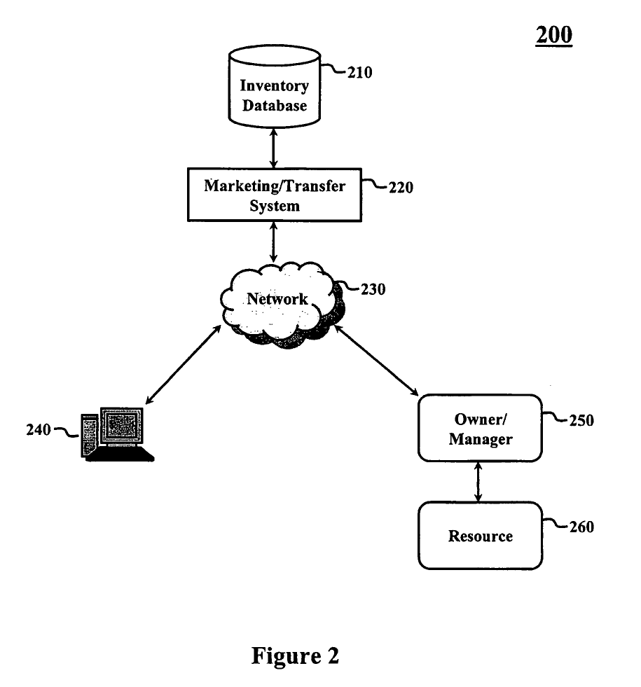

FIG. 2 is an illustration of an example computing environment 200 in which the present invention can be implemented. Computing environment 200 includes an inventory database 210, a marketing/transfer system 220, a network 230, an on-line consumer 240, an owner/manager 250, and a resource 260.

At times herein, the present invention is described with reference to particular applications. However, such description is intended for purposes of illustration and not limitation. The invention is applicable to any time-limited (or time-finite) resources. Additionally, based on the teachings provided herein, it will be apparent to those skilled in the relevant art that the present invention is applicable to resources having limited (or finite) inventory.

Inventory database 210 stores information on available time-limited resources (e.g., resource 260) that can be transferred to consumer 240. Inventory database 210 can store, for example, attributes relating to a location of hotel, availability dates for tickets on a cruise ship, and peak times to visit a particular attraction. The information in inventory database 210 can be populated by owner/manager 250, via network 230, where owner/manager 250 provides a description of resource 260 to marketing/transfer system 220. In turn, marketing/transfer system 220 can assign one or more attributes to each resource so that a keyword search term can be associated with the resource. Resource 260 can be, for example, a time-limited resource as described above with respect to conventional method 100.

Network 230 is optionally either a public or private communications network. For example, network 230 can be the Internet or a private intranet, such as a corporate network. Communications networks are known to those persons skilled in the relevant art.

On-line consumer 240 interacts with marketing/transfer system 220 through network 230. Marketing/transfer system 220 can be an on-line marketing service offering a bid for placement advertising model, where owner/manager 250 selects one or more keywords and offers a bid per click for a link placement in a search result using the keyword(s). On-line consumer 240 can search for resource 260 in inventory database 210 through marketing/transfer system 220 using the keyword search. For instance, consumer 240 can seek to rent a summer vacation home along a beach and enter a term “summer beach house rental” as a keyword search.

Depending on a relevancy between the keyword search and attributes associated with resource 260 and a bid amount offered by owner/manager 250, resource 260 can be displayed in a particular placement in the search result list. On-line consumer 240 can then click on a link of interest and inquire more information on resource 260, if needed.

Marketing/transfer system 220 forwards the inquiry to owner/manager 250, who then may respond to the inquiry. If on-line consumer 240 is satisfied with an item on the search result list, then on-line consumer 240 can negotiate with owner/manager 250 for a transfer (e.g., rent, lease, or purchase) of resource 260.

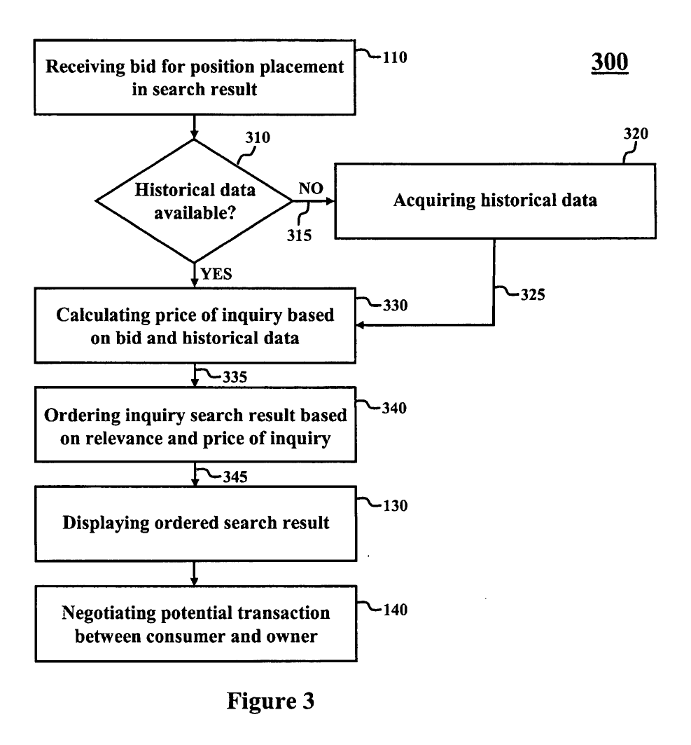

FIG. 3 is an illustration of an embodiment of a method 300 for bidding for position placement in a search result on time-limited resources. Method 300 can occur, for example, using computing environment 200. Steps 110, 130, and 140 are similar to that described above with respect to FIG. 1.

Unlike conventional method 100, method 300 bases its ordering of a search result on relevancy and bid amount. Method 300 can also assess an advertiser's bid amount based on historical data, if available. This historical data can include, for example, a customer's average length of stay, time of season, and a number of inquiries that convert into an actual transaction. Based on the relevancy and historical data features of method 300, advertisers can confidently assess a bid amount in a bid for placement advertising model. Moreover, advertisers with multiple resources can efficiently manage the bidding procedure for each resource.

For ease of explanation, method 300 will be described with a reference example. The example involves a hotel manager (e.g., owner/manager 250 in FIG. 2) seeking to sell hotel rooms (e.g., resource 260 in FIG. 2) for certain time periods. The hotel manager seeks to use an on-line bid for placement advertising model and offers a bid for the search term “beachfront hotel.” Based on the description herein, a person skilled in the relevant art will recognize that the present invention is not limited to this example and that the features discussed in the description of this example can be applied to other time-limited resources. The scope and spirit of the present invention extends to such other time-limited resources.

In referring to FIG. 3, step 310 assesses whether historical data is available on the time-limited resource. Historical data can help an advertiser assess how much a bid is worth based on a likelihood that the time-limited resource will be transferred. For instance, in referring to the hotel example, historical data can show that during a particular time of year, the average length of stay at the hotel is 5 nights and that 1 in 5 inquiries (e.g., on-line consumer contacting the hotel manager for additional information) convert into a booking (e.g., on-line consumer placing a reservation with the hotel manager). Other historical factors can also be used as recognized by a person skilled in the relevant art.

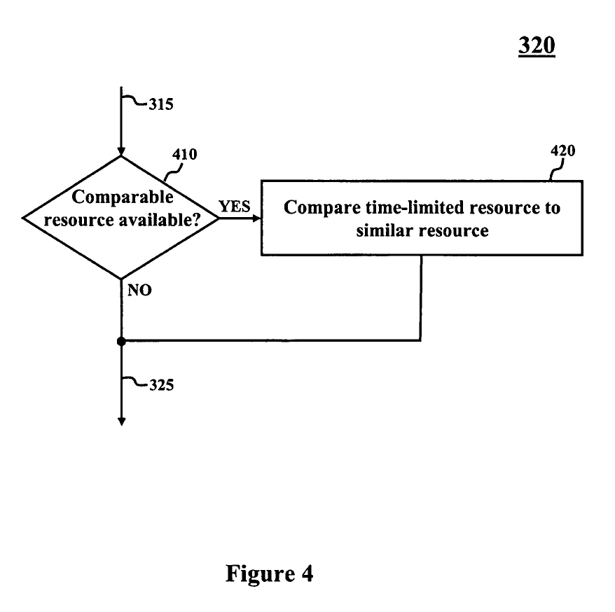

In step 320, if no historical data is available, then this data can be acquired. FIG. 4 is an illustration of an embodiment of step 320. Step 410 assesses whether one or more comparable time-limited resources exist. If so, step 420 compares the subject time-limited resource to other similar resources in order to acquire the historical data. In the hotel example, historical data can be gathered by comparing attributes of the hotel to other similar accommodations in the area. These attributes can include, for example, amenities, pet accommodations, and proximity to a location of interest. If no comparable resources are available, then step 320 proceeds to step 330.

In step 330, an inquiry price is calculated based on the bid and historical data (if available). For example, in referring to the historical factors described above in step 310, the hotel manager can assess that he is willing to pay 10% of a booking to an on-line marketing service if an on-line customer reserves a room in his hotel. In turn, since 1 in 5 inquiries turn into a booking, the hotel manager may also pay 2% of the booking to the on-line marketing service if an on-line customer makes an inquiry on the hotel. Furthermore, the hotel manager may also pay a fee to the on-line marketing service if a customer clicks on the link associated with the hotel. This bid for click fee can be based on a number of click-throughs that convert into an inquiry.

In an embodiment, if there is no historical data that can be used in the calculation of the inquiry price, then the on-line marketing service can negotiate an appropriate inquiry price with the property owner. For instance, the on-line marketing service can suggest an inquiry price based on time-limited resources located in other areas. Based on this inquiry price and a click-through rate over a period of time, the advertiser and on-line marketing service can adjust the inquiry price and/or the keyword search accordingly. In another example, the on-line marketing service can negotiate an inquiry price where the on-line marketing service places the time-limited resource in random positions in the search result (depending on the keyword search terms used). Based on the click-through rate over a period of time, the owner/manager of the time-limited resource can adjust the inquiry price accordingly. A person skilled in the relevant art will recognize that other methods can be used to formulate an inquiry price in the absence of historical data.

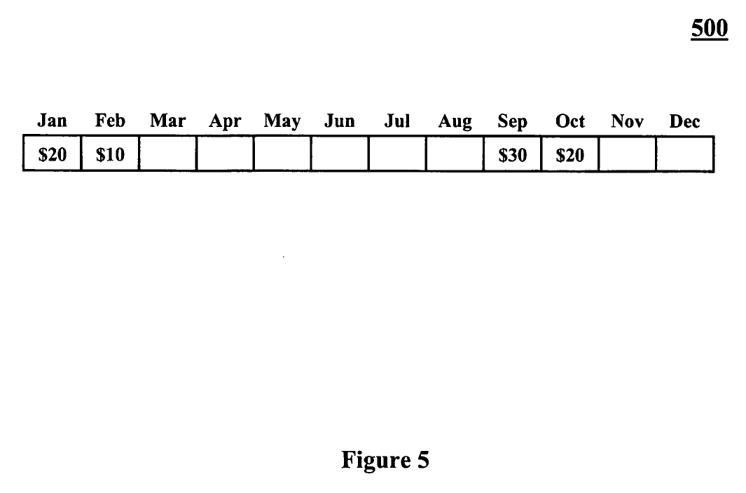

In another embodiment of step 330, a property manager can offer a bid on multiple properties for different time periods. FIG. 5 is an illustration of an example user interface 500 that can be used by a property manager to enter bids for a given resource for different periods of time. As shown in FIG. 5, the property manager placed bids for $20, $10, $30 and $20 for January, February, September, and October, respectively. These bids can represent a variety of prices such as, for example, the price that the owner is willing to pay an on-line marketing service for a booking. A person skilled in the relevant art will appreciate that the bids listed in FIG. 5 can represent other values and that the bids can be for any time period such as, for example, hourly, daily, and monthly periods of time.

Further, in step 330, a person skilled in the relevant art will recognize that a property manager can offer a bid for other events that can trigger a bid fee. Other than an inquiry bid, the property manager can also pay the on-line marketing service a bid for a number of click-throughs for a particular link or a bid for a booking of the time-limited resource. For instance, an individual owner of a time-limited resource may prefer to pay a sales commission (e.g., booking fee), whereas a property manager may prefer to pay for inquiries (e.g., marketing leads). In the alternative, the property manager can pay a fixed fee for a booking (e.g., “pay for purchase” type of bid amount). Since different property owners/managers (e.g., owner/manager 250 in FIG. 2) can bid differently for a given time period (e.g., a combination of inquiry bids, click-through bids, and booking bids), this can add complexity to the ordering of search results in step 340 (described further below).

However, in analyzing on-line behavior of consumers with respect to a given time-limited resource, equivalent comparisons can be made for click-through, inquiry, and booking bids. For example, a particular resource can indicate that, on average, every 10 clicks on a link (e.g., click-through) results in an inquiry and further, for the same resource, every 5 inquiries results in a booking. An owner/manager of this resource may be willing to pay 10% of a booking to an on-line marketing service and, based on the historical data of the resource, may be also willing to pay 2% of the booking for an inquiry and 0.2% of the booking for a click-through. Essentially, step 330 of method 300 determines the values of these types of biddings relative to each other given the historical results of such actions to thereby normalize the value of these bids. Thereafter, a search result can be ordered based on this information.

An advantage of step 330 in method 300 over conventional method 100 is that a property manager with many properties can offer multiple bids for each resource over different time periods. In addition, these bids can be based on historical data where the property manager is not required to continuously track bids to ensure that a bid is in an optimal search result position. In the alternative, the bid amount can be based on a fixed amount offered by the property manager. The bid for placement offered by the property manager is based on the amount that the manager is willing to pay for the bid. In this way, the manager can assess position placement in a search result versus likelihood that an on-line consumer will inquire on the resource.

In referring to method 300 in FIG. 3, step 340 orders a search result based on relevance and price of the inquiry calculated in step 330. In an embodiment of step 340, the search result is first filtered based on relevance and then ordered in the result list based on bid amount. Relevance relates to similarities between a search term used by an on-line consumer and attributes or characteristics of a time-limited resource. Bid amount is described above with respect to step 330. For ease of explanation, the bid amount will be assumed to be a price of an inquiry made by an owner/manager of the time-limited resource.

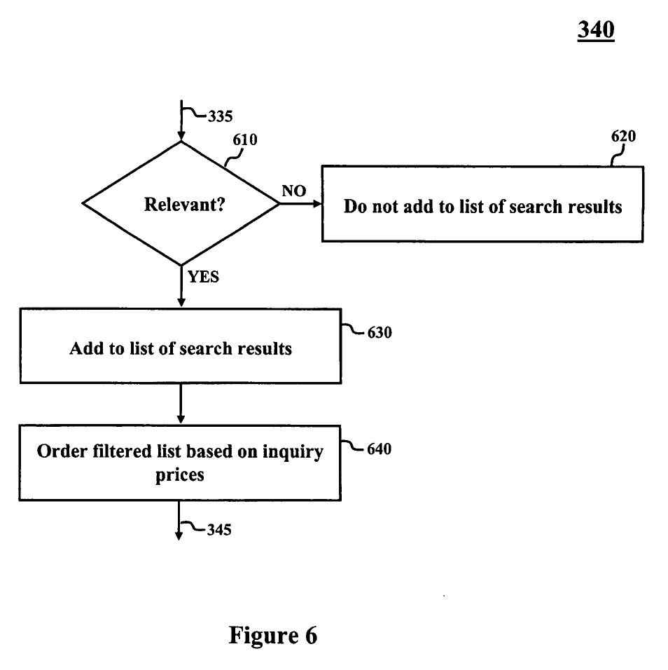

The following discussion relates to the relevancy component of step 340. FIG. 6 is an illustration of an embodiment of step 340. Step 610 filters the search result based on relevance between a search term and a time-limited resource. In referring to the hotel example above, if an on-line consumer enters a search term for “pet-friendly beachfront hotel,” then step 610 compares the search term to attributes of the hotel and other time-limited resources stored in an inventory database (e.g., inventory database 210 in FIG. 2).

In step 620, if the search term is not relevant to an attribute of the time-limited resource, then the resource is not added to a list of search results. On the other hand, in step 630, if the search term is relevant, then the resource is added to the list of search results. For instance, in the hotel example, the search term “pet-friendly beachfront hotel” would be relevant to the hotel and would not be relevant to other time-limited resources such as, for example, museum tours and cruise ship tickets.

Within the relevant category of “hotel,” relevant sub-categories can exist to further refine the relevancy between the search term and the time-limited resource. In the hotel example, the hotel manager may have only offered a bid on the term “beachfront hotel” and not the term “pet-friendly beachfront hotel.” In an embodiment, hotels with attributes of “pet-friendly beachfront hotel” can be placed ahead of hotels that do not have these attributes since time-limited resources with an attribute “pet-friendly beachfront hotel” would be more relevant to a search than a resource associated with the attributes “beachfront hotel.” A person skilled in the relevant art will recognize that for longer strings of keyword searches, the sub-categories for relevancy can grow accordingly.

Once the list of relevant items is compiled, step 640 orders the list of items according to inquiry price. As described above with respect to step 330, if there is no historical data on a particular time-limited resource, then the on-line marketing service can negotiate a bid price with an owner/manager of the resource. In this situation, based on the agreement between the on-line marketing service and the owner/manager, the time-limited resource can be placed in random positions in the search result list to gauge a click-through, inquiry, and booking rate based on these various positions. A person skilled in the relevant art will appreciate that the information gathered from this method can serve as historical data for future bids on the time-limited resource.

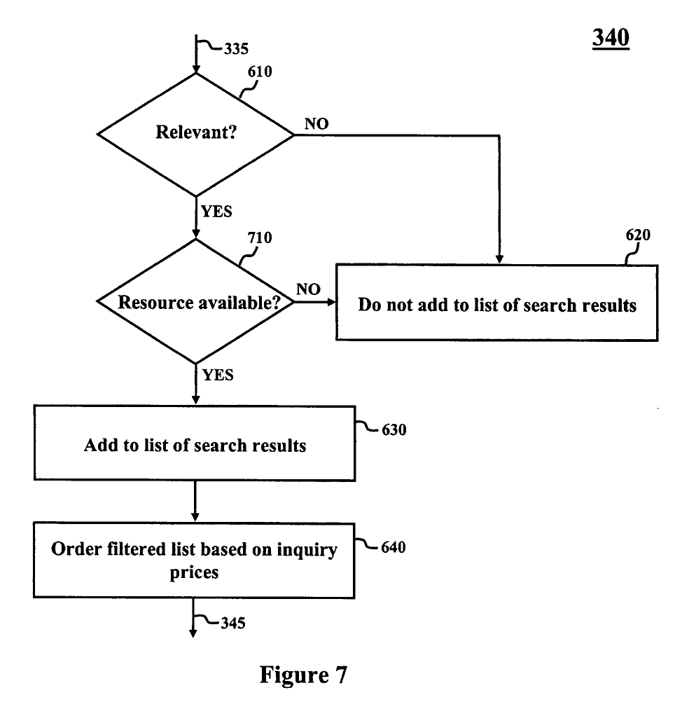

FIG. 7 is an illustration of another embodiment of step 340. Steps 610-640 are similar to that described with respect to FIG. 6. Step 710 assesses whether the resource is available. More specifically, after relevancy is established between the search term and time-limited resources associated with the search term, a resource is placed in the ordered list of search results (step 630) only if the resource is available.

In an embodiment of step 710, the availability information can be provided by the owner/manager of the time-limited resource. The information provided by the owner/manager can include an availability of specific amenities. The amenities can include, for example, a swimming pool and distance to local attractions/venues. The owner/manager may be required to update an inventory database (e.g., inventory database 210 in FIG. 2) to reflect the availability of one or more time-limited resources, along with the availability of amenities at each resource. In having the owner/manager update the inventory database, advertisers using the on-line marketing/transfer system can be ensured that an on-line consumer's inquiry is met by their resource.

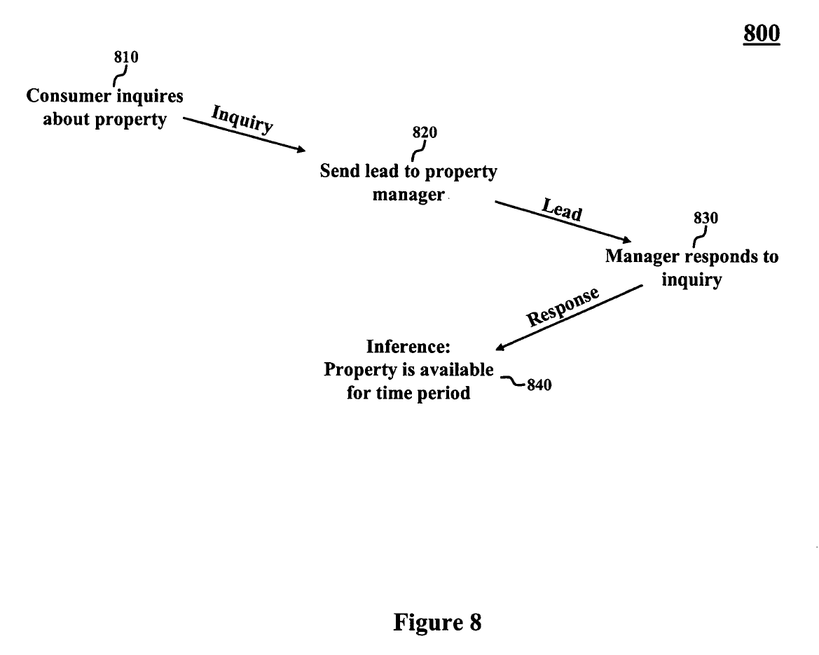

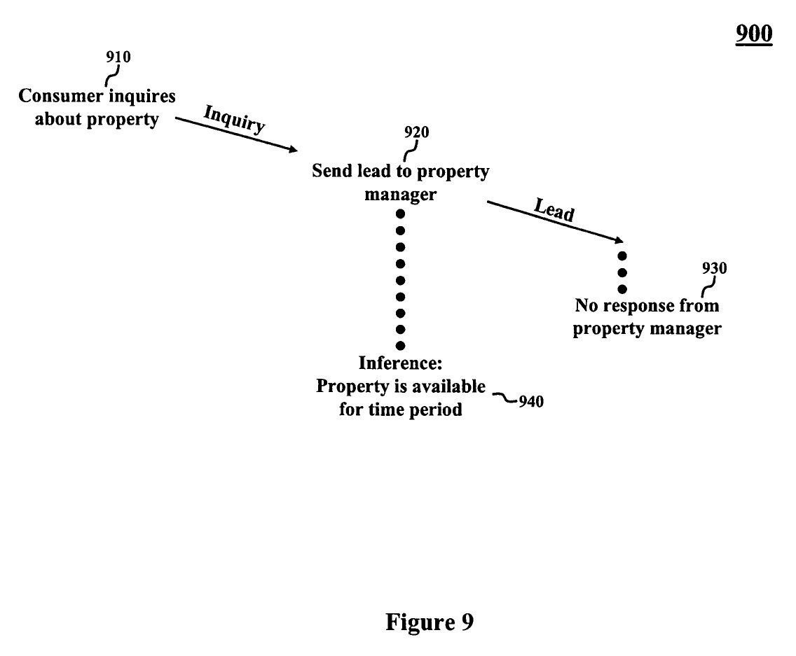

In another embodiment of step 710, the availability of a time-limited resource can be inferred by monitoring interactions between on-line consumers interested in the resource and an owner/manager of the resource. This inference is further described by dataflow diagrams of FIGS. 8 and 9. These figures shall be described with reference to an example where the time-limited resource (e.g., resource 260 in FIG. 2) is a rental vacation property. A person skilled in the relevant art will recognize that the present invention is not limited to this example and that the features discussed in the description of this inference example can be applied to other time-limited resources.

FIG. 8 is an illustration of an example scenario 800 where an on-line consumer inquires about the rental vacation property for a particular time period (see 810). A marketing/transfer system (e.g., marketing/transfer/system 220 in FIG. 2) forwards the inquiry or sales lead (see 820) to the property manager (e.g., owner/manager 250 in FIG. 2) of the rental vacation property, who then responds to the inquiry (see 830). Assuming that the manager responds that the property is available, the marketing/transfer system infers from such interactions that the rental vacation property is available for the time period in question (see 840). The system is justified in making this inference because the actions of the property manager in responding to the inquiry indicate that the manager is interested in renting the property during the time period in question. Since the manager is interested in renting the property, the property is most likely available for rent during the time period in question. A person skilled in the relevant art will also recognize that, in addition to availability, other factors associated with the time-limited resource (e.g., amenities) can be inferred based on an interaction between the on-line consumer and property manager. Based on this interaction, the marketing/transfer system can infer whether the on-line consumer's inquiry is met.

FIG. 9 is an illustration of another example scenario 900 where an on-line customer inquires about the rental vacation property for a particular time period (see 910). A marketing/transfer system (e.g., marketing/transfer system 220 in FIG. 2) forwards the inquiry or sales lead (see 920) to the property manager (e.g., owner/manager 250 in FIG. 2) of the rental vacation property. In this case, the property manager does not respond to the inquiry (see 930). After a number of such “no responses” from the property manager, the marketing/transfer system infers that the property is not available for rent for the time period in question. The marketing/transfer system is justified in making this inference because the actions of the property manager in not responding to one or more inquiries directed to the time period in question indicates that the manager is not interested in renting the property during the time period in question. The number of “no responses” that must occur before the marketing/transfer system makes this inference is an implementation-specific factor that can depend on a number of factors such as, for example, the historical response time of the property manager and the general availability of other homes in the area.

Thus far, inferred availability of time-limited resources has been considered. Another factor closely related to availability is marketability of the time-limited resource since marketability refers to a measure of an ability of the resource to be transferred (e.g., rent, lease, or purchase) to a consumer. For instance, a vacation rental property may not be marketable because it is not available. Alternatively, the vacation rental property might not be marketable for factors other than availability such as, for example, a lack of desired amenities.

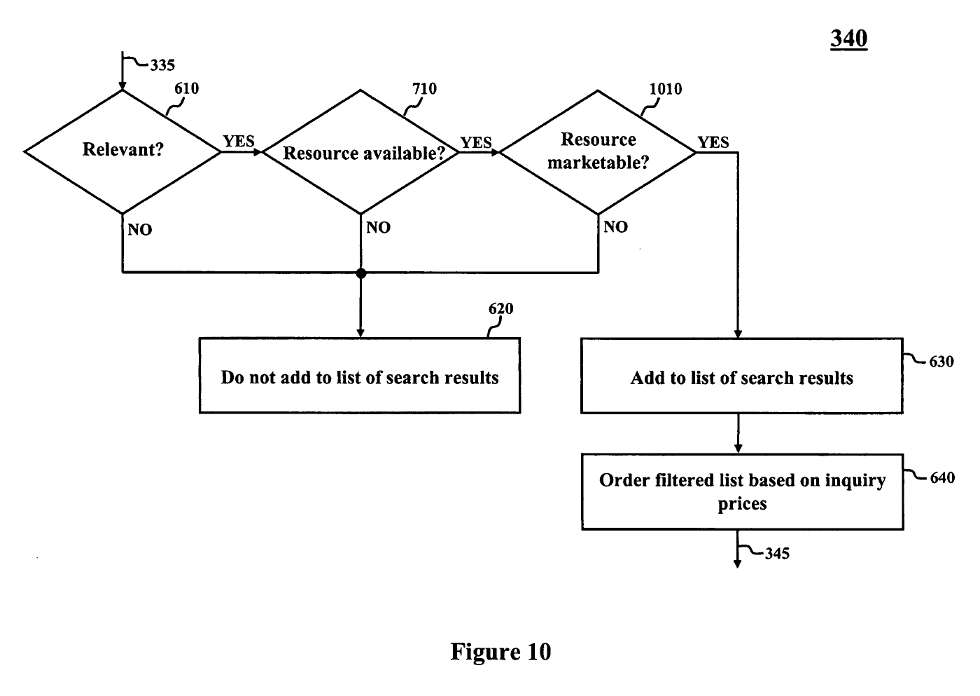

FIG. 10 is an illustration of another embodiment of step 340 from method 300 (in FIG. 3). Steps 610-640 are similar to that described with respect to FIG. 6. Step 710 is similar to that described with respect to FIG. 7. Step 1010 assesses whether the resource is marketable. More specifically, after relevancy and availability are established for the time-limited resource, the resource is placed in the ordered list of search results (step 630) only if the resource is marketable based on factors other than availability.

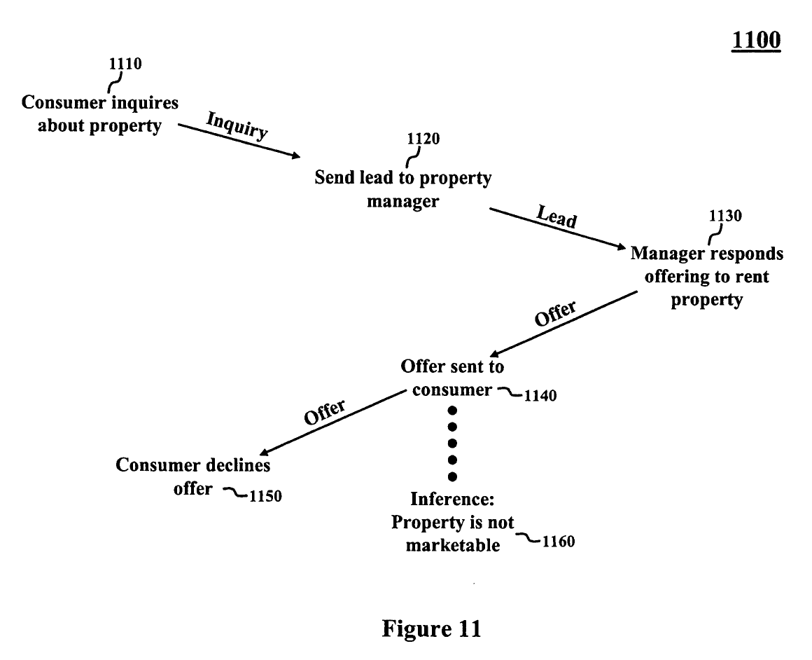

The marketability of a time-limited resource is further described by a dataflow diagram of FIG. 11. FIG. 11 is described with reference to the same example described above with respect to FIGS. 8 and 9. A person skilled in the relevant art will recognize that the present invention is not limited to this example and that the features discussed in the description of this marketability example can be applied to other time-limited resources.

FIG. 11 is an illustration of an example scenario 1100 where an on-line consumer inquires about the rental vacation property for a particular time period (see 1110). A marketing/transfer system (e.g., marketing/transfer system 220 in FIG. 2) forwards the inquiry or sales lead (see 1120) to the property manager (e.g., owner/manager 250 in FIG. 2) of the rental vacation property. The property manager responds to the inquiry with an offer to rent the property to the on-line consumer (see 1130). In turn, the marketing/transfer system forwards the offer to the consumer (see 1140), but the consumer declines the offer (see 1150).

After a number of such “declines” from consumers, the marketing/transfer system infers that the property is not marketable. The inference of non-marketability can be made for the time period in question, or for all time periods, depending on the interactions between on-line consumers and the property manager. Further, these interactions can also be based on other factors such as, for example, whether all the inquiries were for a single time period or were for several time periods. The marketing/transfer system is justified in making this inference because the actions of one or more consumers declining offers to rent the property can indicate some aspect of the property makes it difficult or even impossible to rent. The number of “declines” that must occur before the marketing/transfer system makes this inference is an implementation-specific factor.

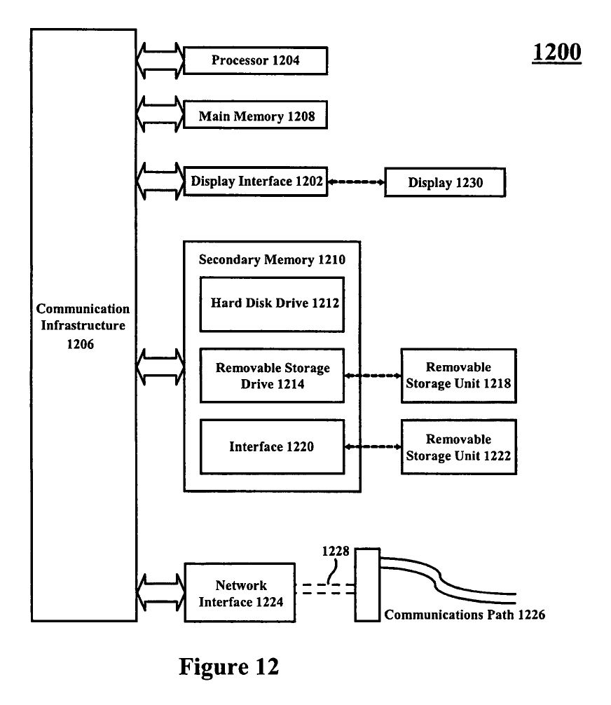

Various aspects of the present invention can be implemented by software, firmware, hardware, or a combination thereof. FIG. 12 is an illustration of an example computer system 1200 in which the present invention, or portions thereof, can be implemented as computer-readable code. For example, the methods illustrated by flowchart 300 of FIG. 3 can be implemented in system 1200. Various embodiments of the invention are described in terms of this example computer system 1200. After reading this description, it will become apparent to a person skilled in the relevant art how to implement the invention using other computer systems and/or computer architectures.

Computer system 1200 includes one or more processors, such as processor 1204. Processor 1204 can be a special purpose or a general purpose processor. Processor 1204 is connected to a communication infrastructure 1206 (e.g., a bus or network).

Computer system 1200 also includes a main memory 1208, preferably random access memory (RAM), and can also include a secondary memory 1210. Secondary memory 1210 can include, for example, a hard disk drive 1212, a removable storage drive 1214, and/or a memory stick. Removable storage drive 1214 can comprise a floppy disk drive, a magnetic tape drive, an optical disk drive, a flash memory, or the like. The removable storage drive 714 reads from and/or writes to a removable storage unit 1218 in a well known manner. Removable storage unit 1218 can comprise a floppy disk, magnetic tape, optical disk, etc. which is read by and written to by removable storage drive 1214. As will be appreciated by persons skilled in the relevant art, removable storage unit 1218 includes a computer-usable storage medium having stored therein computer software and/or data.

In alternative implementations, secondary memory 1210 can include other similar means for allowing computer programs or other instructions to be loaded into computer system 1200. Such means can include, for example, a removable storage unit 1222 and an interface 1220. Examples of such means can include a program cartridge and cartridge interface (such as those found in video game devices), a removable memory chip (e.g., EPROM or PROM) and associated socket, and other removable storage units 1222 and interfaces 1220 which allow software and data to be transferred from the removable storage unit 1222 to computer system 1200.

Computer system 1200 can also include a communications interface 1224. Communications interface 1224 allows software and data to be transferred between computer system 1200 and external devices. Communications interface 1224 can include a modem, a network interface (such as an Ethernet card), a communications port, a PCMCIA slot and card, or the like. Software and data transferred via communications interface 1224 are in the form of signals which can be electronic, electromagnetic, optical, or other signals capable of being received by communications interface 1224. These signals are provided to communications interface 1224 via a communications path 1226. Communications path 1226 carries signals and can be implemented using wire or cable, fiber optics, a phone line, a cellular phone link, a RF link or other communications channels.

In this document, the terms “computer program medium” and “computer-usable medium” are used to generally refer to media such as removable storage unit 1218, removable storage unit 1222, and a hard disk installed in hard disk drive 1212. Signals carried over communications path 1226 can also embody the logic described herein. Computer program medium and computer-usable medium can also refer to memories, such as main memory 1208 and secondary memory 1210, which can be memory semiconductors (e.g., DRAMs, etc.). These computer program products are means for providing software to computer system 1200.

Computer programs (also called computer control logic) are stored in main memory 1208 and/or secondary memory 1210. Computer programs can also be received via communications interface 1224. Such computer programs, when executed, enable computer system 1200 to implement the present invention as discussed herein. In particular, the computer programs, when executed, enable processor 1204 to implement the processes of the present invention, such as the steps in the methods illustrated by flowchart 300 of FIG. 3, discussed above. Accordingly, such computer programs represent controllers of the computer system 1200. Where the invention is implemented using software, the software can be stored in a computer program product and loaded into computer system 1200 using removable storage drive 1214, interface 1220, hard drive 1212 or communications interface 1224.

The invention is also directed to computer program products comprising software stored on any computer-usable medium. Such software, when executed in one or more data processing device, causes a data processing device(s) to operate as described herein. Embodiments of the invention employ any computer-usable or -readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

While various embodiments of the present invention have been described above, it should be understood that they have been presented by way of example only, and not limitation. It will be understood by those skilled in the relevant art that various changes in form and details can be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method for bidding for position placement in a search result on a time-limited resource, comprising:
(a) receiving a bid for position placement of the time-limited resource in the search result;
(b) calculating at least one of an inquiry rate and a click-through rate based on historical data of the time-limited resource; and
(c) ordering the search result based on the at least one of the bid, the inquiry rate, and the click-through rate and relevance between a search term and attributes of the time-limited resource.

2. The method of claim 1, further comprising:
(d) displaying the ordered search result for an on-line consumer; and
(e) negotiating a transaction between the consumer and an owner/manager of the time-limited resource.

3. The method of claim of claim 1, wherein step (a) comprises varying an amount of the bid for one or more time periods of interest.

4. The method of claim 1, wherein step (b) comprises assessing a likelihood that an on-line consumer click-throughs, inquires, or books the time-limited resource.

5. The method of claim 4, wherein assessing the likelihood comprises calculating a ratio representative of a number of click-throughs associated with the time-limited resource that converts into an inquiry on the time-limited resource.

6. The method of claim 4, wherein assessing the likelihood comprises calculating a ratio representative of a number of inquiries on the time-limited resource that converts into a booking of the time-limited resource.

7. The method of claim 1, wherein step (c) comprises ordering one or more results from the search primarily on a number of similarities between the search term and characteristics of the time-limited resource and secondarily on an amount of the at least one of the bid, the inquiry rate, or the click-through rate.

8. The method of claim 1, wherein step (c) comprises randomizing a position of the time-limited resource in the search result when historical data on the time-limited resource is unknown.

9. A computer program product comprising a computer-usable medium having computer program logic recorded thereon for enabling a processor to bid for position placement in a search result on time-limited resources, the computer program logic comprising:
receiving means for enabling a processor to receive a bid for position placement of the time-limited resource in the search result;
calculating means for enabling a processor to calculate at least one of an inquiry rate and a click-through rate based on historical data of the time-limited resource; and
ordering means for enabling a processor to order the search result based on the at least one of the bid, the inquiry rate, and the click-through rate and relevance between a search term and attributes of the time-limited resource.

10. The computer program product of claim 9, the computer program logic further comprising:
displaying means for enabling a processor to display the ordered search result for an on-line consumer; and
negotiating means for enabling a processor to negotiate a transaction between the consumer and an owner/manager of the time-limited resource.

11. The computer program logic of claim 9, wherein the receiving means comprises:
means for enabling a processor to vary an amount of the bid for one or more time periods of interest.

12. The computer program logic of claim 9, wherein the calculating means comprises:
means for enabling a processor to assess a likelihood that an on-line consumer click-throughs, inquires, or books the time-limited resource.

13. The computer program logic of claim 12, wherein the assessing means comprises:
means for enabling a processor to calculate a ratio representative of a number of click-throughs associated with the time-limited resource that converts into an inquiry on the time-limited resource.

14. The computer program logic of claim 12, wherein the assessing means comprises:
means for enabling a processor to assess the likelihood comprises calculating a ratio representative of a number of inquiries on the time-limited resource that converts into a booking of the time-limited resource.

15. The computer program logic of claim 9, wherein the ordering means comprises:
means for enabling a processor to order one or more results from the search primarily on a number of similarities between the search term and characteristics of the time-limited resource and secondarily on an amount of the at least one of the bid, the inquiry rate, and the click-through rate.

16. The computer program logic of claim 9, wherein the ordering means comprises:
means for enabling a processor to randomize a position of the time-limited resource in the search result when historical data on the time-limited resource is unknown.

17. A system for bidding for position placement in a search result on time-limited resources, comprising:
a first module to receive a bid for position placement of the time-limited resource in the search result;
a second module to calculate at least one of an inquiry rate and a click-through rate based on historical data of the time-limited resource; and
a third module to order the search result based on the at least one of the bid, the inquiry rate, and the click-through rate and relevance between a search term and attributes of the time-limited resource.

18. The system of claim 17, further comprising:
a third module to display the ordered search result for an on-line consumer; and
a fourth module to negotiate a transaction between the consumer and an owner/manager of the time-limited resource.

19. The system of claim 17, wherein the first module comprises:
a module to vary an amount of the bid for one or more time periods of interest.

20. The system of claim 17, wherein the second module comprises:
a module to assess a likelihood that an on-line consumer click-throughs, inquires, or books the time-limited resource.

21. The system of claim 17, wherein the third module comprises:
a module to order one or more results from the search primarily on a number of similarities between the search term and characteristics of the time-limited resource and secondarily on an amount of the at least one of the bid, the inquiry rate, and the click-through rate.

22. The system of claim 17, wherein the third module comprises:
a module to randomize a position of the time-limited resource in the search result when historical data on the time-limited resource is unknown.
